(19) United States
(12) Patent Application Publication
(10) Pub. No.: US 2015/0149948 A1
(43) Pub. Date: May 28, 2015

(54) PORTABLE ELECTRONIC DEVICE AND SCREEN CONTROL METHOD THEREFOR

(71) Applicant: Samsung Electronics Co., Ltd., Gyeonggi-do (KR)

(72) Inventor: Jaeku YUN, Gyeonggi-do (KR)

(73) Assignee: Samsung Electronics Co., Ltd.

(21) Appl. No.: 14/550,081

(22) Filed: Nov. 21, 2014

(30) Foreign Application Priority Data
Nov. 22, 2013 (KR) 10-2013-0143178

(51) Int. Cl. G06F 3/0488; G06F 3/0481

(52) U.S. Cl. CPC G06F 3/04886; G06F 3/04817
USPC 715/773

(57) ABSTRACT

A screen control method for a portable electronic device is provided. The screen control method includes receiving a touch event; moving a foreground screen according to the received touch event; and outputting a virtual or soft button corresponding to a hardware button of the portable electronic device at a position close to the moved foreground screen in a display area.

### PRIORITY

This application claims priority under 35 U.S.C. §119(a) to a Korean Patent Application filed on Nov. 22, 2013 in the Korean Intellectual Property Office and assigned Serial No. 10-2013-0143178, the entire content of which is incorporated herein by reference.

### BACKGROUND

1. Field of the Invention

The present invention generally relates to a portable electronic device and screen control method therefor that enable screen movement for easy function execution.

2. Description of the Related Art

A portable electronic device having a large screen may display many application icons associated with various functions on the screen. When a user manipulates a portable electronic device with one hand, for example, while being on a bus or subway train, the user may grip the portable electronic device with one hand and execute a desired function associated with an icon displayed on the screen using a finger of the gripping hand. However, when the screen size is large, the user may have difficulty in reaching a far region of the screen and manipulating icons displayed in the far region with a finger of the hand gripping the portable electronic device. An excessive attempt to reach and manipulate a function icon displayed in the far region of the screen with a finger of the hand gripping the portable electronic device may cause the grip to be unstable, so that the portable electronic device may be dropped and damaged. Otherwise, the user may have to use the other hand to manipulate the portable electronic device.

To solve this problem, the screen may be resized to fit within a region that can be reached by a finger of the hand gripping the portable electronic device, or icons being displayed may be moved to the region.

However, as the screen is resized (or reduced), objects such as application icons displayed on the screen are also reduced. Hence, the user may have difficulty in selecting and executing a desired function. In addition, moving icons displayed on the screen may be not intuitive, and it may be difficult to arrange icons at desired positions with a single operation.

### SUMMARY

The present invention has been made to address at least the above-mentioned problems and/or disadvantages and to provide at least the advantages described below. Accordingly, an aspect of the present invention is to provide a portable electronic device and screen control method therefore, in which a full screen output by the portable electronic device may be moved to a desired position so that a function can be readily executed.

In accordance with an aspect of the present invention, a screen control method for a portable electronic device is provided. The screen control method includes receiving a touch event; moving a foreground screen according to the received touch event; and outputting a virtual or soft button corresponding to a hardware button of the portable electronic device at a position close to the moved foreground screen in a display area.

In accordance with another aspect of the present invention, a portable electronic device is provided. The portable electronic device includes a touchscreen configured to receive a touch event and output a foreground screen; and a control unit configured to control the touchscreen so as to move the foreground screen upon reception of the touch event and output a virtual button corresponding to a hardware button of the portable electronic device at a position close to the moved foreground screen in a display area.

### BRIEF DESCRIPTION OF THE DRAWINGS

The above and other aspects, features, and advantages of certain embodiments of the present invention will be more apparent from the following detailed description, taken in conjunction with the accompanying drawings, in which:

FIG. 1 is a block diagram of a configuration of a portable electronic device according to an embodiment of the present invention;

FIG. 2 is a flowchart of a screen control method for the portable electronic device according to an embodiment of the present invention;

FIG. 3 illustrates screen movement in the portable electronic device according to an embodiment of the present invention;

FIG. 4 illustrates screen movement in the portable electronic device according to another embodiment of the present invention; and

FIGS. 5A-5C illustrate results of screen movement in the portable electronic device according to an embodiment of the present invention.

### DETAILED DESCRIPTION OF EMBODIMENTS OF THE PRESENT INVENTION

Hereinafter, embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention. The following description includes various specific details only to assist understanding of present invention.

In the present invention, the portable electronic device and screen control method therefor may move a full screen to a desired position so that a function can be readily executed. Hence, usability of the portable electronic device may be significantly enhanced.

In an embodiment of the present invention, the portable electronic device is a device having computing resources, such as a smartphone, tablet computer, digital camera, computer monitor, Personal Digital Assistant (PDA), electronic organizer, desktop computer, Portable Multimedia Player (PMP), a media player such as a Moving Picture Experts Group Audio Layer 3 (MP3) player, audio equipment, wrist watch, or game console.

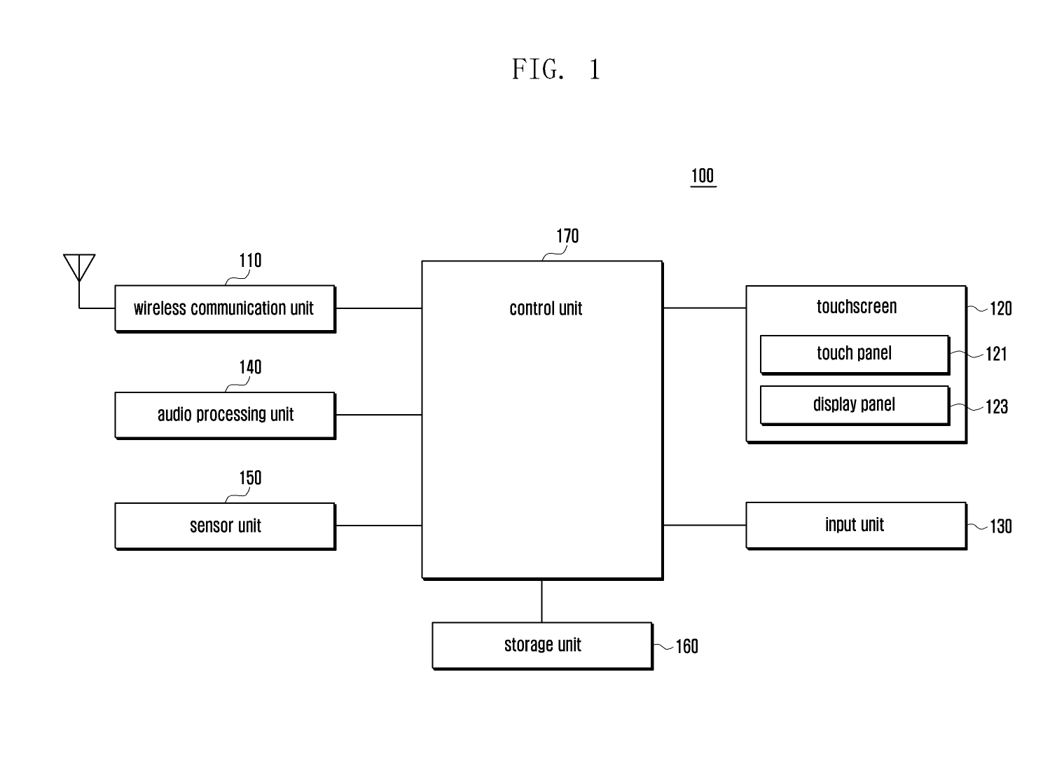

FIG. 1 is a block diagram of a configuration of a portable electronic device 100 according to an embodiment of the present invention.

Referring to FIG. 1, the portable electronic device 100 includes a wireless communication unit 110, a touchscreen 120, an input unit 130, an audio processing unit 140, a sensor unit 150, a storage unit 160, and a control unit 170.

The wireless communication unit 110 establishes a communication channel to a mobile communication network under control of the control unit 170 to send and receive signals in relation to calls (voice call, video call and data call), messages (text message and multimedia message), and Internet services. The wireless communication unit 110 may include a transceiver for upconverting the frequency of a signal to be transmitted and amplifying the signal, and for low-noise amplifying a received signal and downconverting the frequency of the received signal. The wireless communication unit 110 may include a mobile communication module (based on 3G, 3.5G or 4G mobile communication), a digital broadcast reception module (such as a DMB module), and a local area communication module (such as a Wi-Fi module, Bluetooth module or Near Field Communication (NFC) module). The wireless communication unit 110 receives advertisement information for a product, information on an application currently being executed, and information on a widget application from a web server, and forwards the received information to the control unit 170. After moving a foreground screen, the control unit 170 controls the touchscreen 120 to output an advertisement, an application icon, or a widget icon corresponding to the received information in a region of a background screen not overlapped with the foreground screen.

The touchscreen 120 outputs various screens needed for operations of the portable electronic device 100. For example, the touchscreen 120 outputs an idle screen, menu screen, and the like, in the course of operating the portable electronic device 100. The touchscreen 120 includes a touch panel 121 and a display panel 123. The touch panel 121 may be of an add-on type (placed on the display panel 123) or an on-cell or in-cell type (inserted in the display panel 123.

The touch panel 121 generates an analog signal (for example, a touch event) corresponding to a user gesture, converts the analog signal into a digital signal (A/D conversion), and sends the digital signal to the control unit 170. The control unit 170 selects a representative one of multiple touch points on the basis of received information on touch events. The coordinates of touch points may be given in units of pixels. For example, when the screen resolution is 640*480 (the number of horizontal pixels*the number of vertical pixels), x-axis coordinates range from 0 to 640 and y-axis coordinates range from 0 to 480. The control unit 170 determines that a touch input means such as a finger or pen is touched on the touch panel 121 when a touch event is received from the touch panel 121, and determines that the touch input means is released when coordinate information is not received. The control unit 170 determines that the touch input means is moved when the touch point coordinates are changed from (x0, y0) to (x1, y2) and the amount of change (e.g. distance D where D²=(x0−x1)²+(y0−y1)²) is greater than a preset threshold (e.g. 1 mm). Upon detection of a movement of the touch input means, the control unit 170 computes the amount of change in position (dx, dy) and the movement speed of the touch input means. The control unit 170 classifies user gestures on the screen into touch, multi-touch, tap, double tap, long tap, tap and touch, drag, flick, press, pinch in, and pinch out on the basis of touch point coordinates, and release, movement, amount of change in position and movement speed of the touch input means.

In particular, the touch panel 121 detects a user gesture for activating a screen movement function and sends information thereof to the control unit 170. For example, the touch panel 121 generates a touch event corresponding to a touch gesture, such as a double tap or a long tap, made by the user and forwards the touch event to the control unit 170. Here, the double tap or the long tap is used as an example of a user gesture for activating a screen movement function, and is not limited thereto. Upon reception of the touch event from the touch panel 121, the control unit 170 moves the current foreground screen. More specifically, the touch panel 121 generates a touch event for screen movement and sends the touch event to the control unit 170. For example, the touch panel 121 generates a touch event corresponding to a user gesture involving touch and movement, such as a drag or flick, and sends the touch event to the control unit 170. In response to the touch event, the control unit 170 moves the current foreground screen. For example, when the user makes a drag gesture for screen movement, the control unit 170 receives a touch event corresponding to the drag gesture from the touch panel 121 and analyzes changes in touch points. The control unit 170 controls the touchscreen 120 to move the foreground screen according to the changes in touch points. After movement of the foreground screen, when the user makes a touch gesture for restoring the previous position of the foreground screen, the touch panel 121 generates a corresponding touch event and sends the touch event to the control unit 170. Upon reception of the touch event from the touch panel 121, the control unit 170 controls the touchscreen 120 to move the foreground screen to the previous position. For example, in response to a touch gesture like a double tap on the foreground screen having been moved, the control unit 170 controls the touchscreen 120 to move the foreground screen to the previous position. Here, in addition to the double tap, other touch gestures such as a long tap may be used to restore the previous position of the foreground screen.

The touch panel 121 may be a composite one of a hand touch panel sensing a hand gesture and a pen touch panel sensing a pen gesture. The hand touch panel may be realized using capacitive, resistive, infrared, or surface acoustic wave technology. The hand touch panel generates a touch event according to not only a hand gesture of the user but also a different object (e.g. an object made of a conductive material capable of causing a capacitance change). The pen touch panel may be realized using electromagnetic induction technology. The pen touch panel generates a touch event according to interaction with a stylus touch pen specially designed to form a magnetic field.

The display panel 123 displays data on the screen under control of the control unit 170. That is, when the control unit 170 stores processed (e.g. decoded) data in a buffer, the display panel 123 converts the data stored in the buffer into an analog signal and displays the analog signal on the screen. In particular, under control of the control unit 170, the display panel 123 displays a foreground screen that can be moved according to a touch event for screen movement received from the touch panel 121. When the foreground screen is moved, the display panel 123 outputs a virtual button corresponding to a hardware button of the portable electronic device 100 at a position close to the moved foreground screen in a display area. For example, when the foreground screen is moved by the user to a desired position, under control of the control unit 170, the display panel 123 outputs a visible region of the foreground screen and outputs a virtual or soft button for the foreground screen so that the position of the virtual button relative to the foreground screen corresponds to the position of a hardware button relative to the touchscreen 120. In other words, when the foreground screen is moved, the touchscreen 120 outputs a virtual button at a position close to the foreground screen in a display area after movement so that the position of the virtual button corresponds to the change in position of the foreground screen. Here, the function mapped to the virtual button is identical to that mapped to the corresponding hardware button. For example, when the hardware button is a volume adjustment button, the virtual button to be output close to the moved foreground screen in a display area is also a volume adjustment button. When the hardware button is a menu button, the virtual button to be output close to the moved foreground screen in a display area is also a menu button. In addition, under control of the control unit 170, the display panel 123 outputs an advertisement, an application icon, or a widget icon in a region of a background screen not overlapping the moved foreground screen.

The display panel 123 may be realized using one of display technologies based on Liquid Crystal Display (LCD) devices, Active Matrix Organic Light Emitting Diodes (AMOLEDs), Passive Matrix Organic Light Emitting Diodes (PMOLEDs), flexible display, and transparent display.

The input unit 130 may include a plurality of buttons for entering alphanumeric information and for setting various functions. Such buttons includes a menu invoking button, screen on/off button, power on/off button, cancel button, and volume adjustment button. The input unit 130 generates button events for user's settings and controlling functions of the portable electronic device 100 and sends the button events to the control unit 170. The control unit 170 controls the above components according to button events. A button of the input unit 130 is referred to as a hardware button, and a virtual button displayed on the display panel 123 is referred to as a soft button.

The audio processing unit 140 may include a coder/decoder (codec). The codec has a data codec for processing packet data and the like, and an audio codec for processing an audio signal such as a voice signal. The audio processing unit 140 converts a digital audio signal into an analog audio signal through the audio codec to output the analog audio signal to a receiver or speaker, and converts an analog audio signal from a microphone into a digital audio signal through the audio codec.

The sensor unit 150 senses a physical quantity (such as amount of light, speed, acceleration, altitude, or gravity) or a change therein and sends sensed information to the control unit 170. The sensor unit 150 may include an acceleration sensor, geomagnetic sensor, pressure sensor, and infrared sensor. In particular, the sensor unit 150 senses motion of the portable electronic device 100 such as shaking or tilting and sends the sensed information to the control unit 170, which then activates the screen movement function or moves the foreground screen being output. For example, the portable electronic device 100 is pre-configured to activate the screen movement function when shaken in a preset pattern. As another example, the portable electronic device 100 is pre-configured to move the foreground screen in the direction of tilt, when tilted in a direction while the screen movement function is activated.

The storage unit 160 may include a disk, Random Access Memory (RAM), and flash memory as a secondary memory for the control unit 170. Under control of the control unit 170, the storage unit 160 stores data generated by the portable electronic device 100 or data received from a server or desktop computer through the wireless communication unit 110 or an external interface. In particular, the storage unit 160 stores advertisement information for a product received from a web server through the wireless communication unit 110, information on an application currently being executed, and information on a widget application. When the foreground screen is moved in response to a touch event for screen movement, the control unit 170 receives at least one of advertisement information, application information, and widget information from the storage unit 160, and outputs the received information in a region of the background screen not overlapping the moved foreground screen.

The storage unit 160 stores an operating system (OS) for operating the portable electronic device 100, application programs to support optional functions such as sound reproduction, playback of still and moving images, and broadcast reception, user data, and data sent and received through communication. In particular, the storage unit 160 stores a screen movement support program. The screen movement support program may be composed of a routine to move the foreground screen according to received information on a touch event (i.e. information on the touch point, direction and distance of movement of a touch gesture), a routine to output a virtual button corresponding to a hardware button of the portable electronic device 100 at a position close to the moved foreground screen in a display area, and a routine to output an advertisement, an application icon and a widget icon in a region of the background screen not overlapping the foreground screen.

The control unit 170 controls the overall operation of the portable electronic device 100, control signal exchange between internal components thereof, and performs data processing. The control unit 170 controls supply of power from a battery to the internal components. In particular, the control unit 170 activates a screen movement function in response to a touch event received from the touch panel 121 or the sensor unit 150. The control unit 170 moves the current foreground screen in a specific manner. For example, when a touch event corresponding to a drag is received from the touch panel 121, the control unit 170 moves the foreground screen in accordance with the direction and distance of the drag. The control unit 170 divides the display area into multiple subregions according to a preset rule, and moves the foreground screen on the basis of the arrangement of the subregions. For example, it is assumed that the display area is evenly divided into 9 rectangular subregions (3 rows and 3 columns). Then, in response to a touch gesture like a drag or flick, the control unit 170 moves the foreground screen and adjusts the position of the foreground screen so that, when one vertex of the foreground screen is placed within one of the subregions, the vertex of the foreground screen becomes coincident with one of the vertices of the subregion that is nearest to the vertex of the foreground screen. When the foreground screen is moved in response to a touch event, the control unit 170 controls the touchscreen 120 to output advertisements, application icons, and widget icons stored in the storage unit 160 in a region of the background screen not overlapping the foreground screen.

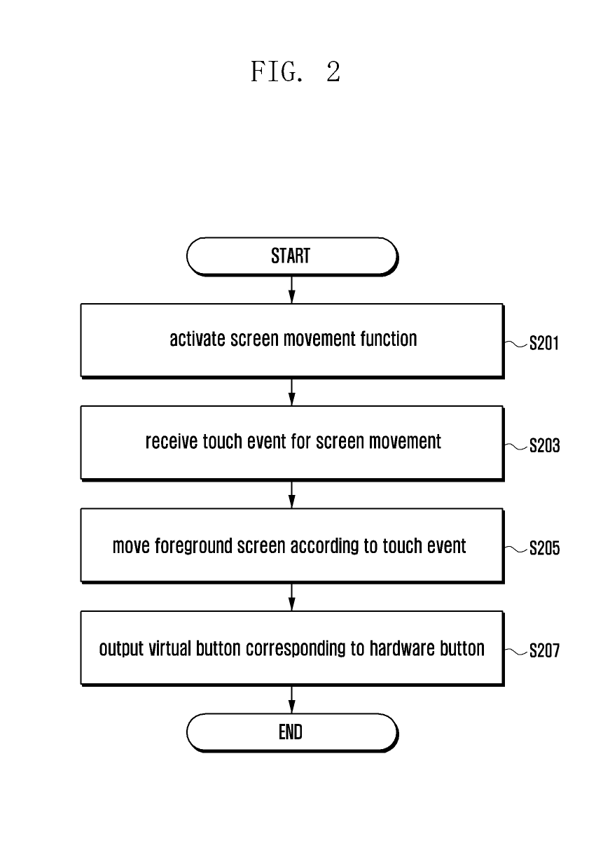

FIG. 2 is a flowchart of a screen control method for the portable electronic device 100 according to an embodiment of the present invention.

Referring to FIG. 2, in step S201, the control unit 170 activates a screen movement function. For example, the control unit 170 activates the screen movement function upon reception of a touch event corresponding to a double tap or a long tap from the touch panel 121. As another example, the control unit 170 activates the screen movement function in response to a motion event such as shaking of the portable electronic device 100 detected by the sensor unit 150. Here, a touch event such as a double tap or a long tap and a motion event such as shaking are described, but are not limited thereto. The screen movement function may also be activated in response to a touch gesture such as press or a motion event such as snap.

In step S203, the control unit 170 receives a touch event for screen movement. For example, the control unit 170 receives a touch event corresponding to a drag or flick on the foreground screen. As another example, the control unit 170 receives a motion event corresponding to tilting of the portable electronic device 100 from the sensor unit 150.

In step S205, the control unit 170 moves the current foreground screen according to the received touch event for screen movement. In one embodiment of the present invention, the control unit 170 performs screen movement in accordance with a received touch event. For example, when the user makes a drag gesture using a finger on the screen, the control unit 170 identifies the touch point, direction, distance and release point of the drag and moves the whole foreground screen according to the identified touch and release points. To move the foreground screen, the control unit 170 may translate the coordinate system of the foreground screen on the basis of touch and release points of the drag. As another example, when a motion event such as shaking is detected by the sensor unit 150, the control unit 170 moves the current foreground screen. In addition, when the portable electronic device 100 is tilted in a particular direction, the sensor unit 150 having an acceleration sensor, gyroscope and/or geomagnetic sensor may send information on the tilting direction to the control unit 170, which may then move the foreground screen in accordance with the tilting direction.

In another embodiment of the present invention, the control unit 170 analyzes a received touch event and moves the current foreground screen to a preset position according to the touch event. For example, the control unit 170 evenly divides the display area into nine rectangular subregions (e.g., 3 rows and 3 columns) according to a preset rule. Then, in response to release of the drag on the touchscreen 120, the control unit 170 moves the foreground screen and adjusts the position of the foreground screen so that, when a visible vertex of the foreground screen is placed within one of the subregions, the visible vertex of the foreground screen becomes coincident with one of the four vertices of the subregion nearest to the visible vertex of the foreground screen. In other words, when the display area is divided into rectangular subregions, the foreground screen is moved so that the visible vertex (among the four vertices) of the foreground screen coincides with one of the four vertices of a subregion that is nearest to the visible vertex of the foreground screen. The number of subregions in the display area may be determined according to user's or designer's settings.

In addition, while a touch event is being received (for example, from the start of a drag action to the end thereof), the control unit 170 may output the foreground screen as a moving entity. When the foreground screen is scheduled to move to a designated region according to a drag event, the control unit 170 may control the touchscreen 120 to adjust the shade, brightness, and chroma of the designated region so that the designated region is readily distinguished from other regions.

In step S207, the control unit 170 outputs a virtual button corresponding to a hardware button of the portable electronic device 100 at a position close to the moved foreground screen in a display area on the touchscreen 120. For example, the control unit 170 outputs a virtual button corresponding to a hardware button such as the menu button, screen on/off button, power on/off button, or volume adjustment button in accordance with the position of the foreground screen. The control unit 170 outputs a virtual button for the foreground screen so that the position of the virtual button relative to the foreground screen corresponds to the position of a hardware button relative to the touchscreen 120. In other words, when the screen is moved by ΔX along the x-axis and ΔY along the y-axis, the virtual button may be output at a position computed by changing the position of the corresponding hardware button by ΔX along the x-axis and ΔY along the y-axis.

After moving the foreground screen, the control unit 170 may control the touchscreen 120 to output advertisements, application icons, and widget icons in a region of the background screen not overlapping the foreground screen. For example, the control unit 170 receives advertisement information through the wireless communication unit 110, and retrieves information on applications currently being executed and information on widget applications from the storage unit 160. The control unit 170 controls the touchscreen 120 to output advertisements, application icons and widget icons in a region of the background screen not overlapping the foreground screen on the basis of the received or retrieved information.

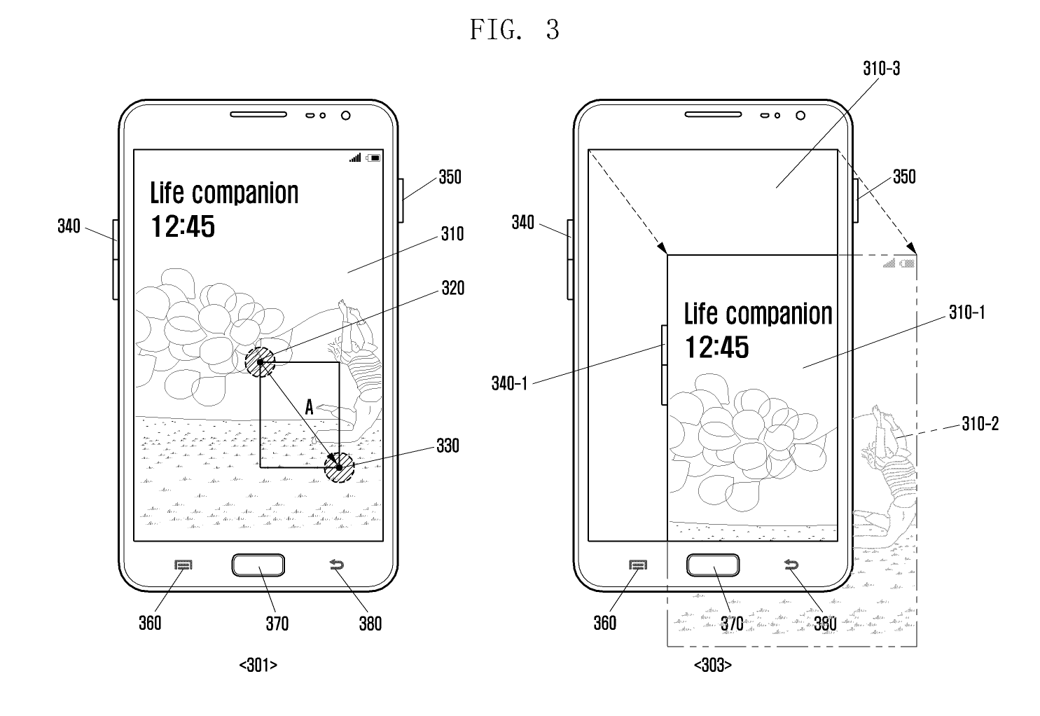

FIG. 3 illustrates screen movement in the portable electronic device 100 according to an embodiment of the present invention.

Referring to FIG. 3, the portable electronic device 100 may have hardware buttons, including a volume adjustment button 340, menu invoking button 360, screen on/off button 370, cancel button 380, and power on/off button 350 formed at sides of the body. Here, the hardware buttons and positions thereof are described, but are not limited thereto. Additional buttons may be added and positions of the buttons may be varied.

Referring to 301 of FIG. 3, the portable electronic device 100 has a screen with the display area 310, and the user may make a drag or flick gesture. The start point and end point of the gesture are indicated by an arrow A.

Referring to 303 of FIG. 3, the portable electronic device 100 outputs a foreground screen 310-1 as an idle screen in the display area. Instead of an idle screen, a menu screen containing icons or other objects, or an application screen may be output. The foreground screen 310-1 may be moved according to user input. The portable electronic device 100 outputs the moved foreground screen 310-1 and a background screen 310-3 in a region of the display area not overlapped with the foreground screen 310-1. Here, the region 310-2 of the foreground screen 310-1 outside of the display area is not displayed. The current position of the foreground screen 310-1 may be determined by changing the previous position of the foreground screen 310-1 in a direction and distance proportional to the direction and distance of user input (e.g. arrow A). As the foreground screen 310-1 is moved in a lower right direction, a virtual button 340-1 corresponding to the volume adjustment button 340 of 301 is output. The output virtual button may be different according to the movement direction of the foreground screen 310-1. For example, if the foreground screen 310-1 is moved in an upward direction, virtual buttons corresponding to the hardware buttons arranged at the lower end of the portable electronic device 100 (e.g. menu invoking button 360, screen on/off button 370, and cancel button 380) would be output close to the moved foreground screen 310-1 in the display area.

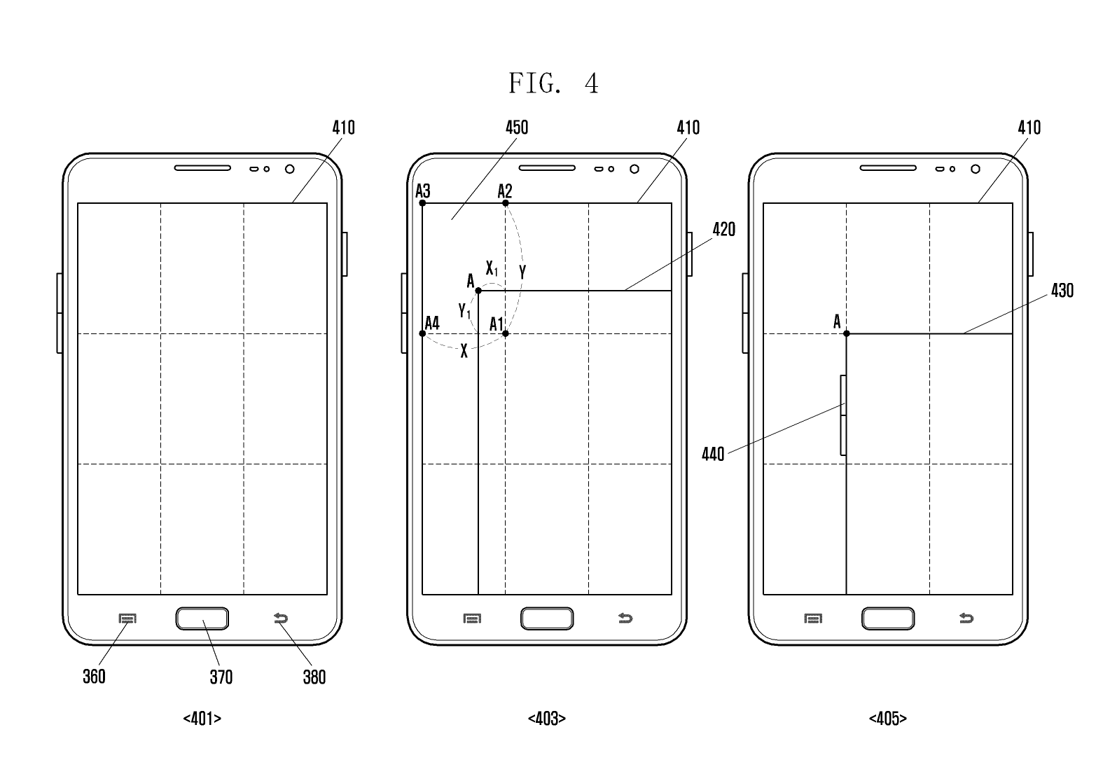

FIG. 4 illustrates screen movement in the portable electronic device 100 according to another embodiment of the present invention.

Referring to 401 of FIG. 4, the display area 410 is divided into multiple subregions. Although the display area 410 is depicted as being evenly divided into 9 rectangular subregions (3 rows and 3 columns), the display area 410 may also be divided into m*n subregions (m rows and n columns).

Referring to 403 of FIG. 4, when a touch event corresponding to a touch gesture like a drag is received, the control unit 170 analyzes the touch event and moves the current foreground screen 420 to a preset subregion. When the visible vertex A of the foreground screen 420 is placed within a subregion 450 after movement, the position of the foreground screen 420 is adjusted so that the visible vertex A of the foreground screen 420 becomes coincident with one of the vertices (A1, A2, A3, A4) of the subregion 450 that is nearest to the visible vertex A of the foreground screen 420. Here, the vertex A of the foreground screen 420 is made to coincide with the vertex A1 of the subregion 450. Specifically, the visible vertex A of the foreground screen 420 is placed within a subregion 450 whose x-axis length and y-axis length are X and Y, respectively. The distance between the visible vertex A and the A2-A1 line is X1, and the distance between the visible vertex A and A4-A1 line is Y1, When ½*X>X1 and ½*Y>Y1 (that is, vertex A is nearest to A1 among A1, A2, A3, A4), the position of the foreground screen 420 is adjusted so that the visible vertex A of the foreground screen 420 is made to coincide with the vertex A1 of the subregion 450.

Referring to 405 of FIG. 4, after movement and position adjustment, the foreground screen 420 is aligned with a preset subregion. However, the movement is not limited thereto, and the foreground screen may be moved in different ways. Alternatively, even when the screen is moved by a smallest amount, the foreground screen can be made to align with a preset subregion. For example, when ½*X<X1 and ½*Y<Y1 of 403, the foreground screen 420 may be made to align with a preset subregion.

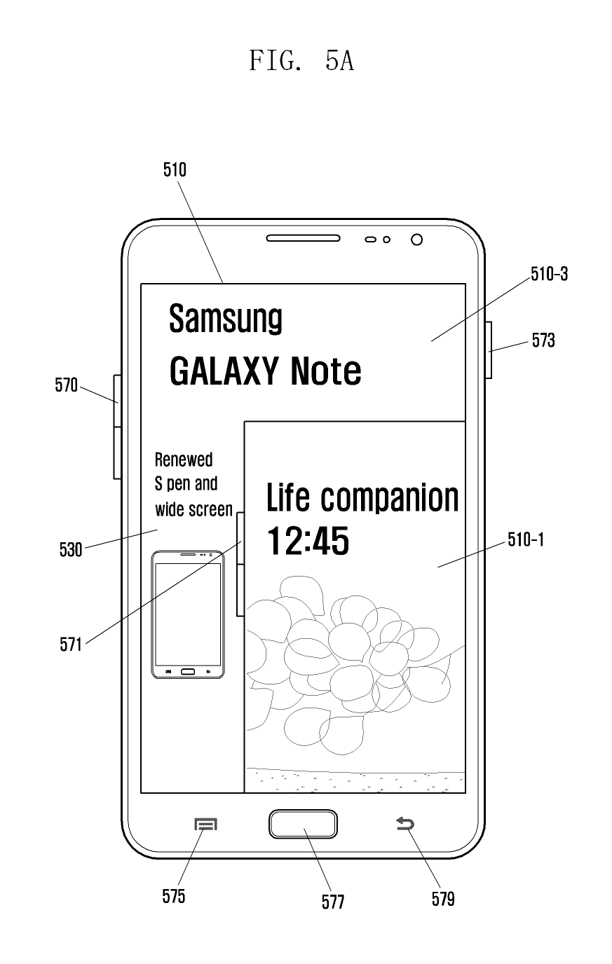

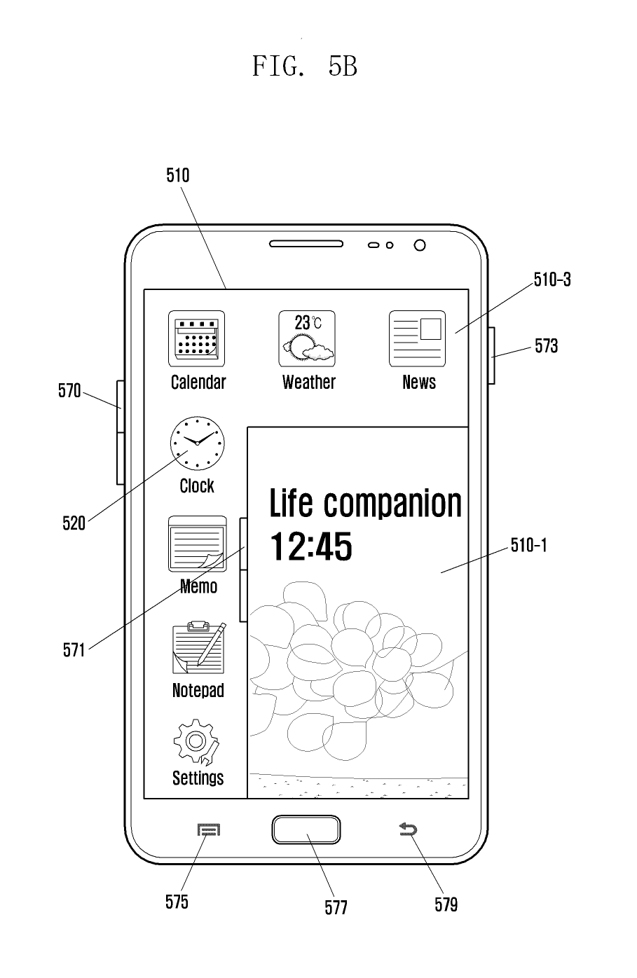

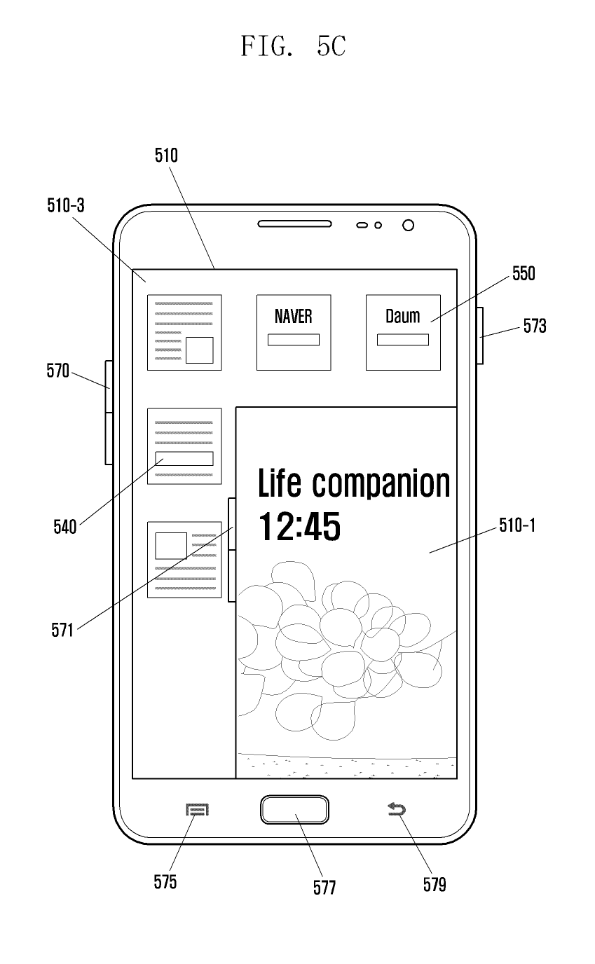

FIGS. 5A-5C illustrate results of screen movement in the portable electronic device 100 according to an embodiment of the present invention.

As shown in FIG. 5A, in the display area 510, the control unit 170 outputs advertisements in a region of the background screen 510-3 not overlapping the moved foreground screen 510-1. Specifically, when the foreground screen 510-1 is moved, the control unit 170 controls the touchscreen 120 to output an advertisement 530 received through the wireless communication unit 110 in a region of the background screen 510-3 not overlapping the moved foreground screen 510-1. In FIG. 5A, a virtual button 571 corresponding to the volume adjustment button 570 is output. However, according to the movement direction of the foreground screen 510-1, virtual buttons corresponding to the menu invoking button 575, screen on/off button 577, cancel button 579, and power on/off button 573, may be output close to the moved foreground screen 510-1 in the display area.

As shown in FIG. 5B, in the display area 510, the control unit 170 outputs widget icons 520 in a region of the background screen 510-3 not overlapping the moved foreground screen 510-1. In FIG. 5B, widget icons 520 related to news, weather, calendar, memo, notepad, and settings widgets are output together with the moved foreground screen 510-1.

As shown in FIG. 5C, in the display area 510, the control unit 170 outputs information on currently executed applications in a region of the background screen 510-3 not overlapping the moved foreground screen 510-1. Information on currently executed applications is output as an icon 550 or as a miniaturized output window 540 for a webpage.

In FIGS. 5A to 5C, the foreground screen is moved in a lower right direction. When the foreground screen is moved in a different direction, the position of a region of the background screen not overlapping the moved foreground screen may be varied accordingly. When the foreground screen is moved in a direction indicated by user input, advertisements, application icons, and widget icons may be output in the region of the background screen not overlapping the foreground screen.

As described above, the portable electronic device and screen control method therefor of the present invention enable the user to move the full screen in a desired direction. As the user can easily execute functions or applications, usability of the portable electronic device can be significantly enhanced.

Hereinabove, various embodiments of the present invention has been shown and described for the purpose of illustration without limiting the subject matter of the present invention. It should be understood by those skilled in the art that many variations and modifications of the method and apparatus described herein will still fall within the spirit and scope of the present invention as defined in the appended claims and their equivalents.

What is claimed is:

1. A screen control method for a portable electronic device, the screen control method comprising:
receiving a touch event;
moving a foreground screen according to the received touch event; and
outputting a virtual button corresponding to a hardware button of the portable electronic device at a position close to the moved foreground screen in a display area.

2. The screen control method of claim 1, wherein outputting a virtual button comprises outputting a virtual button so that the position of the virtual button relative to the moved foreground screen corresponds to the position of the hardware button relative to a touchscreen.

3. The screen control method of claim 1, wherein a function mapped with the virtual button is the same as a function mapped with the hardware button.

4. The screen control method of claim 1, wherein receiving the touch event comprises receiving user input for activating a screen movement function.

5. The screen control method of claim 4, wherein receiving the user input for activating a screen movement function comprises receiving at least one of a touch event corresponding to a touch gesture and a motion event corresponding to a motion of the portable electronic device.

6. The screen control method of claim 1, wherein moving the foreground screen comprises translating a coordinate system of the foreground screen.

7. The screen control method of claim 1, wherein moving the foreground screen comprises:
dividing the display area into multiple subregions;
moving the foreground screen upon reception of the touch event; and
adjusting a position of the foreground screen so that the foreground screen is aligned with at least one of the subregions.

8. The screen control method of claim 1, wherein outputting the virtual button comprises outputting at least one of an advertisement, application icon, and widget icon in a region of a background screen not overlapping the moved foreground screen.

9. The screen control method of claim 1, further comprising:
receiving user input for restoring a previous position of the foreground screen; and
moving the foreground screen to the previous position according to the received user input.

10. A portable electronic device comprising:
a touchscreen configured to receive a touch event and output a foreground screen; and
a control unit configured to control the touchscreen so as to move the foreground screen upon reception of the touch event and output a virtual button corresponding to a hardware button of the portable electronic device at a position close to the moved foreground screen in a display area.

11. The portable electronic device of claim 10, wherein the control unit is further configured to control the touchscreen to output a virtual button so that the position of the virtual button relative to the moved foreground screen corresponds to the position of the hardware button relative to the touchscreen.

12. The portable electronic device of claim 10, wherein a function mapped with the virtual button is the same as a function mapped with the hardware button.

13. The portable electronic device of claim 10, wherein the touchscreen is further configured to receive user input for activating a screen movement function.

14. The portable electronic device of claim 13, wherein the user input for activating a screen movement function is at least one of a touch event corresponding to a touch gesture and a motion event corresponding to a motion of the portable electronic device.

15. The portable electronic device of claim 10, wherein the control unit is further configured to translate a coordinate system of the foreground screen upon reception of the touch event to move the foreground screen.

16. The portable electronic device of claim 10, wherein the control unit is further configured to divide the display area into multiple subregions upon reception of the touch event, to move the foreground screen according to the touch event, and to adjust a position of the foreground screen so that the foreground screen is aligned with at least one of the subregions.

17. The portable electronic device of claim 10, wherein the control unit is further configured to control the touchscreen to output at least one of an advertisement, application icon, and widget icon in a region of a background screen not overlapping the moved foreground screen.

18. The portable electronic device of claim 10, wherein the touchscreen is further configured to receive user input for restoring a previous position of the foreground screen, and
wherein the control unit is further configured to control the touchscreen to move the foreground screen to the previous position according to the received user input.
